(19) United States
(12) Patent Application Publication
(10) Pub. No.: US 2004/0194077 A1
(43) Pub. Date: Sep. 30, 2004

(54) Methods and apparatus to collect profile information

(76) Inventors: Jayashankar Bharadwaj, Saratoga, CA (US); Dong-Yuan Chen, Fremont, CA (US); Ali-Reza Adl-Tabatabai, Santa Clara, CA (US)

Correspondence Address: James A. Fligh, GROSSMAN & FLIGHT LLC, Suite 4220, 20 North Wacker Drive, Chicago, IL, 60606-6357, US

(21) Appl. No.: 10/401,438

(22) Filed: Mar. 28, 2003

(51) Int. Cl. G06F 9/45

(52) U.S. Cl. 717/158; 717/140

(57) ABSTRACT

Methods and apparatus to collect profile information with respect to computer program block(s) are disclosed. A disclosed method collects profile information with respect to target code by predicating execution of profile collection code on a predicate register value; setting the predicate register value to a first predetermined value to permit execution of the profile information collection code to collect profile information with respect to the target code; and setting the predicate register value to a second predetermined value to prevent execution of the profile collection code.

### FIELD OF THE DISCLOSURE

This disclosure relates generally to software optimization, and, more particularly, to methods and apparatus to collect profile information with respect to software.

### BACKGROUND

Computer programmers have long profiled the computer programs they write in an effort to optimize their operation. To perform this optimization, the programmer often inserts instrumentation or data collection code into the program at issue to collect profile information concerning that program. Examples of profile information that may be collected include: (a) control flow data such as block counts (i.e., the number of times a particular block of code is executed), edge counts (i.e., the number of times a particular entry or exit to/from a block of code is executed), and path execution counts (i.e., the number of times a particular execution path is traversed), and (b) program values such as argument values (e.g., numeric values assigned to variables) and argument types (e.g., a floating point numeral, an integer, etc.). Once this information is collected, a compiler/optimizer or the programmer may analyze the collected data to determine if refinements to the program should be made to optimize its performance.

Recently, compilers and translators have been developed which seek to optimize code execution at run time. To accomplish this optimization, such dynamic compilers/translators typically require profile data feedback. The profile data collected and fed-back to the compiler through, for example, profiling instrumentation inserted into the compiled code, allows the compiler to extract instruction-level parallelism and to specialize the program for commonly occurring execution paths and values. Efficient profiling is especially important in these dynamic compilation systems where profiling overhead is part of the host or application program's execution time on the end user's system. Examples of dynamic compilation systems include managed runtime environments such as Java and Common Language Infrastructure (CLI) and binary translation systems.

In the Java context, Java bytecodes or applets available on the Internet are frequently downloaded to a client device. A just-in-time (JIT) compiler executing on the client device compiles the Java bytecodes into a language readable by the client device shortly before the compiled code is to be executed. The compiled code is then executed within a virtual machine. To obtain feedback regarding the operation of the compiled code, the JIT compiler may insert profiling instrumentation code into the compiled code to profile various characteristics of the code (e.g., control flow, program values and/or other program characteristics). The profile information fed-back by this instrumentation can be used to optimize the compiled code. However, such profiling instrumentation is disadvantageous in that the time spent executing the instrumentation is frequently a significant component of the overall execution time of the program. For example, profiling instrumentation may increase the overhead of a host program by as much as 30%-1000%. This disadvantage is not limited to JIT compilers, but includes other types of compilers operating in different contexts and/or languages, such as static compilers for C, C++, Fortran, etc.

To reduce the overhead associated with the profiling instrumentation approach discussed above, a technique referred to as “bursty-profiling” has been developed. In bursty-profiling, the compiler generates two versions of the code being compiled. One copy of the compiled code is fully instrumented. The second copy of the compiled code is minimally instrumented. Control transfers between the two versions of the code at specific points (e.g., at loop backedge or method/routine/function entry) thereby having the effect of switching the profiling code on and off to create a sampling effect. This bursty-profiling technique is advantageous over earlier techniques in that it reduces the overhead associated with profile collecting (e.g., from 30-3000% to around 3%). Bursty-profiling is disadvantageous, however, in that it inherently doubles the code size, which has negative effects on the instruction cache, the trace cache and TLB (Translation Look-aside Buffer) performance. Moreover, branch prediction may not be performed as well in the bursty-profiling context due to the doubling of the number of static branch instructions.

### BRIEF DESCRIPTION OF THE DRAWINGS

FIG. 1 is a schematic illustration of an example apparatus to collect profile information.

FIGS. 2A-2B are a flowchart representative of machine readable instructions which may be executed to implement the apparatus of FIG. 1.

FIG. 3 is a schematic illustration of example pseudo-code which may be used to implement the machine readable instructions represented by the flowchart of FIGS. 2A-2B.

FIG. 4 is a schematic illustration of example pseudo-code which may be used to implement the machine readable instructions represented by the flowchart of FIGS. 2A-2B.

FIG. 5 is a schematic illustration of example pseudo-code which may be used to implement the machine readable instructions represented by the flowchart of FIGS. 2A-2B.

FIG. 6 is a flowchart representative of machine readable instructions which may be executed by a compiler to create the apparatus of FIG. 1.

FIG. 7 is a schematic illustration of an example computer that may be used to execute the program of FIGS. 2A-2B to implement the apparatus of FIG. 1.

### DETAILED DESCRIPTION

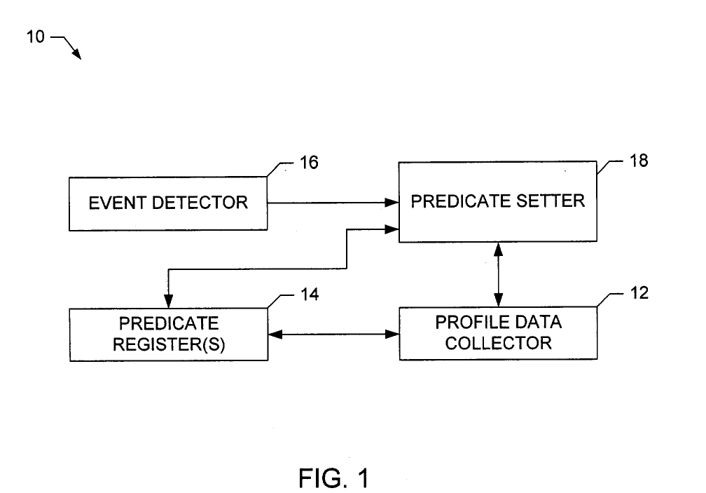

FIG. 1 is a schematic illustration of an example apparatus 10 to collect profile data with respect to a computer program or section of a computer program. As explained in detail below, the illustrated apparatus 10 is structured to selectively turn on and off a data collection engine as is done in the bursty-profiling process discussed above to thereby control the amount of overhead associated with profiling the program or section of program of interest. However, unlike the bursty-profiling technique, the illustrated apparatus 10 accomplishes this selective gathering of profile data without doubling the code size and without suffering the adverse consequences associated with such code size doubling.

Although the illustrated apparatus 10 may be used to collect profile data with respect to an entire program, for simplicity of discussion the illustrated example assumes that the apparatus 10 is only used to collect data with respect to one or more sections of a program such as one or more basic blocks, loops, routines or other regions of code. For simplicity of terminology, the program or section(s) of the program being profiled will be referred to herein as a “target block,” and persons of ordinary skill will understand this term to refer to a program or any portion or portions of a program of interest. Further, persons of ordinary skill in the art will appreciate that the illustrated apparatus 10 may be used in a virtual machine such as a Java or CLR virtual machine, and/or in a static profile guided optimization tool such as a compiler, a translator, and/or a binary optimizer. Alternatively, it may be used as a testing tool. Moreover, persons of ordinary skill in the art will appreciate that the illustrated apparatus 10 may be a runtime component, or it may be compiled into the code being profiled.

For the purpose of collecting profile data with respect to target code, the apparatus 10 is provided with a profile data collector 12. The profile data collector 12 is only invoked to collect profile data with respect to the target code when a predicate register 14 contains a predetermined value (e.g., true). When invoked, the profile data collector 12 may collect any desired type of profile data. For example, the profile collector 12 may be structured to collect profile data relating to any of (a) a method/routine execution count, (b) a block execution count, (c) an edge (i.e., a control flow edge from one basic block to another) execution count, (d) a path (i.e., a control flow sequence of basic blocks) execution count, (e) a call graph (i.e., a graph showing the connectivity between routines), (f) an argument value, (g) an argument type, and/or (h) a stride (i.e., the change in a value of a variable between two lookups).

As mentioned above, the profile data collector 12 is adapted for use with one or more predicate registers 14 such as the predicate registers implemented in the Intel Itanium® family of processors. In the Itanium® family of processors, a predicate register 14 is a hardware accessible register that stores true or false data. A predicate register 14 may be associated with one or more instructions in a software or firmware program. When the Itanium® processor executes the program, before executing a program instruction, the processor (or a portion of the processor which may be dedicated to reading and/or predicting predicate values in predicate registers) determines if that program instruction is associated with a predicate register 14. If so, the processor checks the predicate value (i.e., true or false) in the associated predicate register 14. This check must occur before the processor commits any changes to user-visible program state arising from the execution of the instruction. If, on the other hand, the associated predicate register 14 contains a value of “true,” then the processor executes the associated instruction just as if there was no predicate register associated with the instruction. If, on the other hand, the associated predicate register 14 contains a value of “false,” then the processor does not make any user-visible program state changes implied by execution of the associated instruction and advances to the next instruction (which may or may not also be associated with the same or a different predicate register 14) in the program flow. The processor may simply do this by not executing the instruction associated with the “false” predicate register value. Because the examination of the predicate register 14 is performed by the Itanium® processor's hardware, instructions associated with “false” predicate values may be read and skipped very quickly thereby expediting program execution beyond that typically achievable using software flow control. In other words, it typically takes less time to read an instruction and a predicate register then to read and execute control flow instructions in the program being executed. Therefore, using the predicate registers as a mechanism to determine if an instruction should be executed is a very fast alternative to guarding execution of instructions by changing program control flow.

Although persons of ordinary skill in the art will readily appreciate that the predicate registers present in the Itanium® family of processors are an advantageous way to implement the predicate register(s) 14, the predicate register(s) 14 may be implemented by other architectural techniques including conditional move or conditional skip instructions. Thus, the apparatus 10 is not limited to use with the Itanium® family of processors.

In order to determine when to set the predicate register(s) 14 to a value selected to invoke the profile data collector 12, the apparatus of FIG. 1 is further provided with an event detector 16. The event detector 16 may be structured to respond to any desired event to instruct a predicate setter 18 that a value in one or more predicate register(s) 14 should be set to a predetermined value (i.e., true or false) required to cause the profile data collector 12 to collect profile information. The predetermined event(s) may include, for example, (a) invoking the target block a predetermined number of times, (b) invoking a routine executed by an operating system a predetermined number of times, (c) invoking a garbage collector a predetermined number of times, (d) invoking a predetermined routine a predetermined number of times, (e) invoking a routine associated with the target routine a predetermined number of times; (f) certain specific system or operating system events, (g) certain metrics collected by the processor (e.g., performance monitoring events), and/or (h) elapse of a predetermined length of time. In the above examples (a)-(e), the predetermined number of times may be any integer value greater than or equal to one and may be different or the same in any or all of the examples (a)-(e). The event(s) monitored by the event detector 16 are selected to ensure collection of the desired type of profile information. For example, if control flow data is desired, it may be appropriate to monitor the invocation of one or more blocks or routines, whereas if program value information is desired, it may be appropriate to use time, or the number of times the value is accessed, as the measure for triggering the predicate setter 18.

Irrespective of the type of event(s) that the event detector 16 is structured to monitor, the predicate setter 18 is structured to respond to detection of the predetermined event(s) to set the predicate register(s) 14 to a predetermined value (e.g., true or false). Thus, when the event detector 16 detects a predetermined event, the predicate setter 18 responds by setting the predicate register(s) 14 to a value that causes the profile data collector 12 to start collecting profile data for the target routine. After the profile data collector 12 has collected a predetermined amount of profile information with respect to the target routine, one or more predetermined events have occurred, and/or after a predetermined amount of time has elapsed, the predicate setter 18 re-sets the predicate register(s) 14 to a value that causes the profile data collector 12 to stop collecting data until the event detector 16 detects another trigger event to again start the data collection process. Varying the frequency with which the predicate register(s) 14 are toggled between the value(s) to invoke and turn off the profile data collector 18 varies the sampling rate at which the profile data is collected.

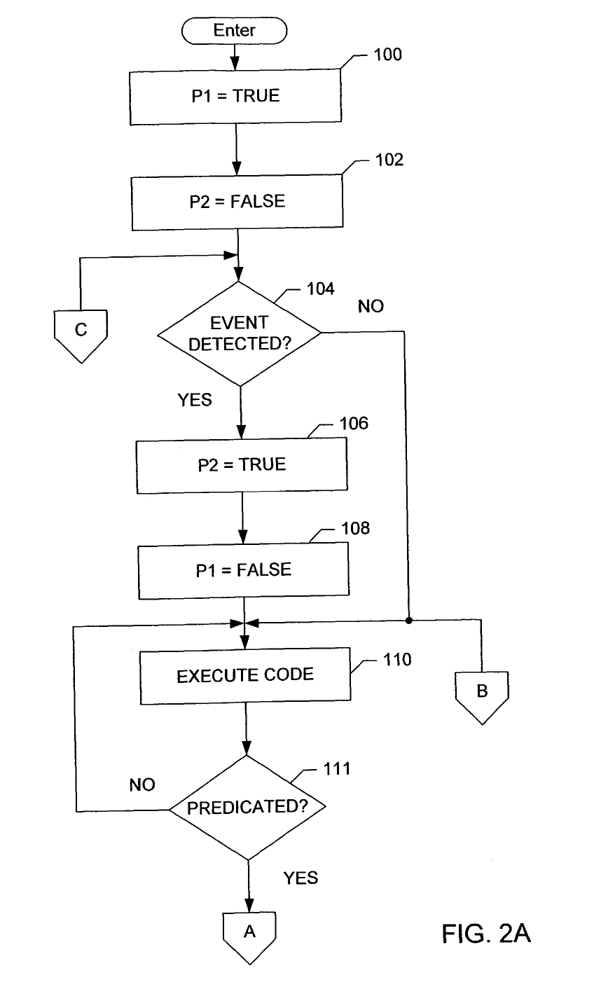

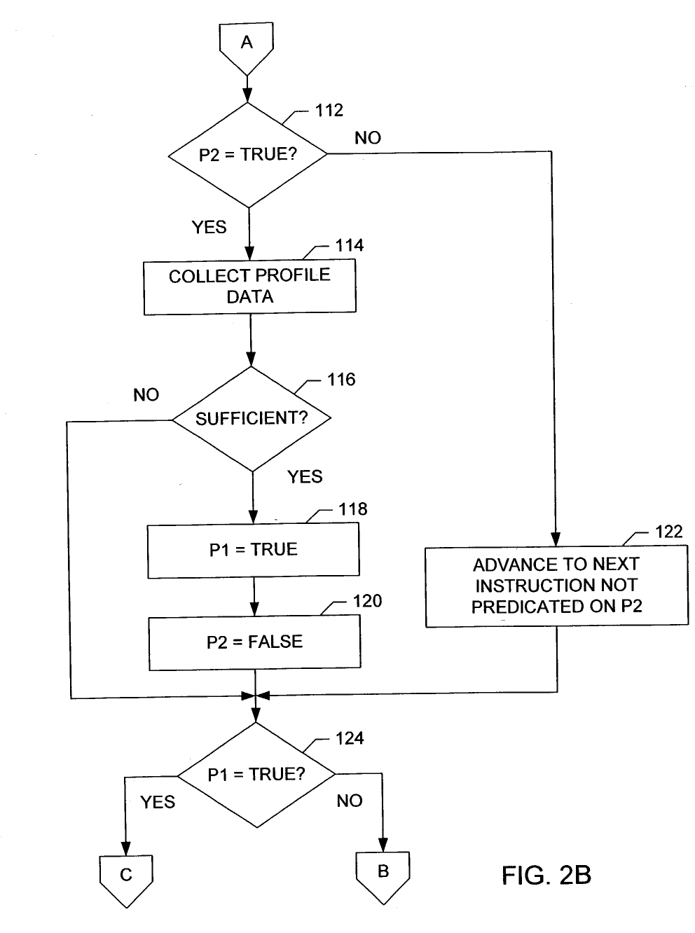

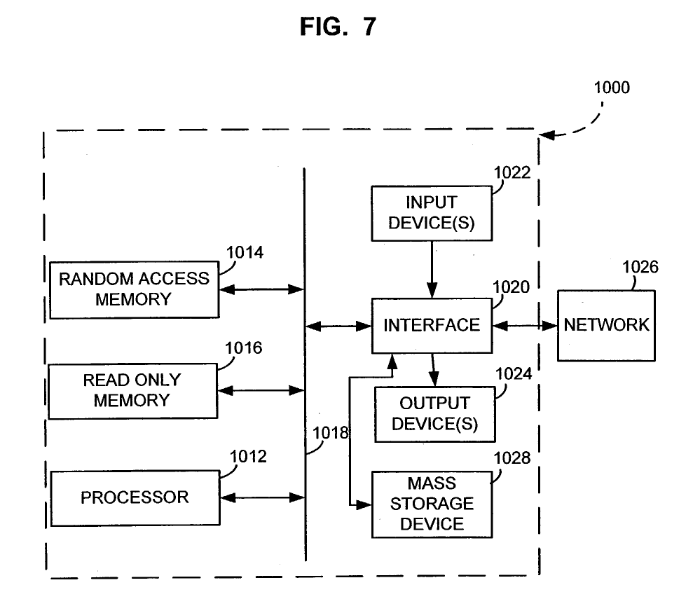

A flowchart representative of example machine readable instructions for implementing the apparatus 10 of FIG. 1 is shown in FIGS. 2A-2B. In this example, the machine readable instructions comprise a program for execution by a processor such as the processor 1012 shown in the example computer 1000 discussed below in connection with FIG. 7. The program may be embodied in software stored on a tangible medium such as a CD-ROM, a floppy disk, a hard drive, a digital versatile disk (DVD), or a memory associated with the processor 1012, but persons of ordinary skill in the art will readily appreciate that the entire program and/or parts thereof could alternatively be executed by a device other than the processor 1012 and/or embodied in firmware or dedicated hardware in a well known manner. For example, any or all of the profile data collector 12, the event detector 16, and/or the predicate setter 18 could be implemented by software, hardware, and/or firmware. Further, although the example program is described with reference to the flowchart illustrated in FIGS. 2A-2B, persons of ordinary skill in the art will readily appreciate that many other methods of implementing the example apparatus 10 may alternatively be used. For example, the order of execution of the blocks may be changed, and/or some of the blocks described may be changed, eliminated, or combined.

In the program of FIGS. 2A-2B, the profile data collector 12 is implemented by software or firmware code, and execution of this profile collection code is predicated on a predicate register value appearing in a predicate register 14. In other words, the instruction(s) in the profile collection code include a predicate statement which may be implemented by a prefix that indicates that the instruction is only to be executed by the processor if the predicate register associated with the predicate statement has a first predetermined value such as “true.” If the predicate register includes a second predetermined value such as “false,” the profile collection code does not need to be executed thereby potentially avoiding the overhead associated with executing that code. Thus, the predicate register 14 is set to the first predetermined value to permit execution of the profile collection code, and set to the second predetermined value to prevent execution of the profile collection code.

The program of FIGS. 2A-2B begins at block 100 where the predicate setter 18 initializes a first predicate register 14 (e.g., predicate register P1) to a predetermined value (e.g., true) which permits execution of the event detector 16. The predicate setter 18 also sets a second predicate register 14 (e.g., predicate register P2) to a predetermined value (e.g., false) that prevents execution of the profile collection code (block 102). Control then advances to block 104 where the event detector 16 determines if a predetermined event has occurred. If a predetermined event has not occurred (block 104), control advances to block 110. If, on the other hand, a predetermined event has occurred (block 104), the predicate setter 18 sets the second predicate register (P2) to a predetermined value (e.g., true) to permit execution of the profile collection code (block 106) and sets the first predicate register (P1) to a predetermined value (e.g., false) to prevent execution of the event detector 16 (block 108). Control then advances to block 1 10.

Although in the example of the preceeding paragraph, the event detector 16 and the profile collection code are executed at mutually exclusive times, persons of ordinary skill in the art will readily appreciate that this need not be the case. For example, the event detector 16 may alternatively be used to both set and clear the predicate register associated with profiling.

At block 110, the processor continues to execute the software program which is subject to profiling. If, in the course of that execution, the program flow reaches a predicated instruction (block 111), control advances to block 112. Otherwise, the program instructions are sequentially executed as dictated by the control flow of those instructions.

Assuming for purposes of discussion that a predicated instruction is reached (block 111), control advances to block 112 (FIG. 2B). If the predicated instruction is a profile collection instruction (i.e., an instruction predicated on the predicate register P2), the processor determines if the predicate register P2 contains a true or false value (block 112). If the predicate register P2 contains a value of “false,” control advances to the next sequential instruction that is not predicated on predicate register P2 (block 122). This advancement may be accomplished by examining the predicate values (if any) of the following instructions in the ordinary course of program flow. Since the instructions predicated on predicate register P2 are not executed, there is little overhead associated with advancing through those instructions to an instruction that is either not predicated, or predicated on a predicate register different from predicate register P2.

If, at block 112, the predicate register P2 contains a value of “true,” a predetermined event has been detected by the event detector 16 and control advances to block 114 where the profile collection instruction(s) predicated on the value in the predicate register P2 are read and executed (i.e., the profile data collector 12 is invoked). Control then advances to block 116.

At block 116, the predicate setter 18 determines if sufficient data has been collected by the profile data collector 12. As explained above, this determination can be made based on a length of time that the profile collector 12 has been active (e.g., a length of time that the predicate register P2 has been set to true), the number of executions of the profile collection code comprising the profile data collector 12 (block 114), and/or any other measure of the amount of data collected by the profile data collector 12. If sufficient profile data has not been collected (block 116), control advances to block 124. If, on the other hand, sufficient profile data has been collected (block 116), the predicate setter 18 re-sets the value in the predicate register P1 to true to thereby enable the event detector 16 (block 118) and re-sets the value in the predicate register P2 to false to thereby deactivate the profile data collector 12 (block 120). Control then advances to block 124.

Persons of ordinary skill in the art will readily appreciate that the event detector 16, the predicate setter 18 and/or the mechanism to activate/deactivate profile collection may alternatively be asynchronous to the program being optimized. In other words, the event detector 16, the predicate setter 18 and/or the mechanism to activate/deactivate profile collection may be part of some program other than the program being profiled, wherein the program being profiled and the other program are executing simultaneously.

If at block 124, the program flow reaches an event detection instruction (i.e., a software instruction predicated on the predicate register P1), the processor determines if the predicate register P1 contains a true or false value (block 124). If the predicate register P1 contains a value of “false” (block 124), control returns to block 110 where execution of the program being profiled continues without invoking the event detector. If, on the other hand, the predicate register P1 contains a value of “true.” Control returns to block 104. Control continues to loop through blocks 104-124 until, for example, the program is terminated, or the “target block” is dynamically recompiled/re-optimized.

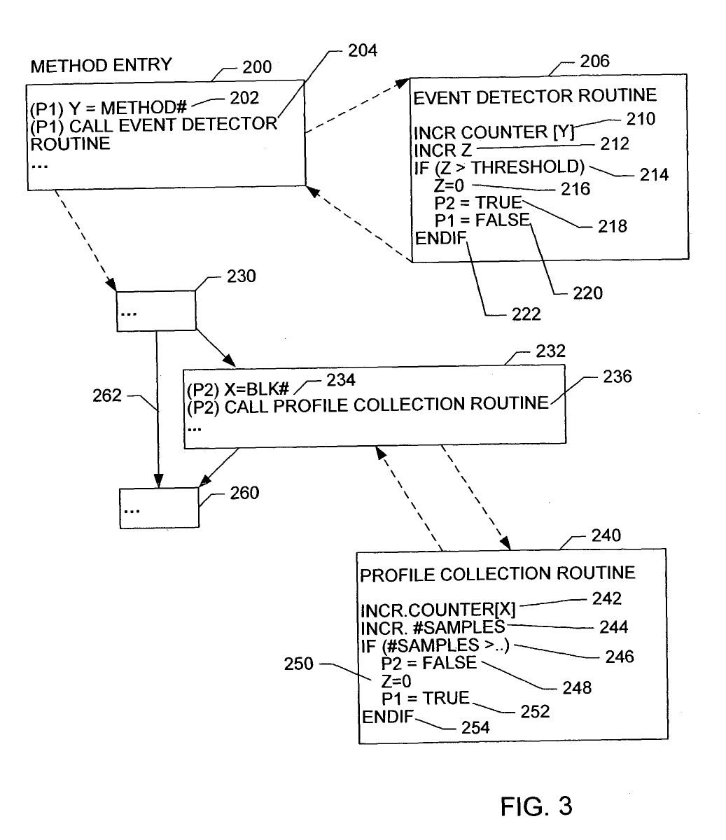

FIGS. 3-5 are schematic illustrations of example pseudo-code which may be used to implement the machine readable instructions represented by the flowchart of FIGS. 2A-2B. In the example of FIG. 3, two predicate registers (e.g., the IPF predicate registers of the Itanium® processor) are globally reserved for profile instrumentation purposes. The profile instrumentation of the example of FIG. 3 includes predicated calls or branches to code that increments profile counters. Predicate P1 is set to true and predicate P2 is set to false at the start of the execution and toggled between true and false periodically to emulate sampling of the profile data. To stop the collection of profile data, the predicate triggering collection of that data is set to false within the profile collection code. This action is triggered when a sufficient amount of profile information has been collected.

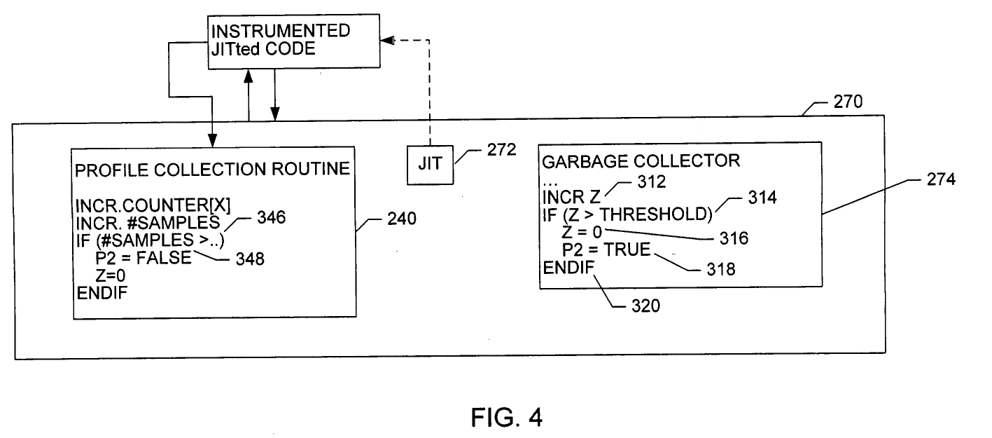

After some time has elapsed, the predicate is again toggled to true to resume profile collection. This resumption can be performed in many ways. In the example of FIG. 3, the instrumentation layer that collects routine and/or backedge execution counts controls the re-setting of the predicate used for all block/edge profile collection (i.e., after a certain number of routine entries and/or loop backedges are executed, block/edge profile collection is resumed). In the example of FIG. 4, the resumption of profile collection is preformed by re-setting the predicates during the execution of lower level software such as the operating system and/or a virtual machine/emulator on top of which the instrumented code is executing. For instance, profile collection may be resumed by toggling the predicates during a call into the virtual machine or a call to a garbage collector.

More specifically, in the example of FIG. 3, a method entry block 200 is provided with two instructions 202, 204 which are predicated on a predicate register P1. If the predicate register P1 contains a value of false (e.g., 0), the predicated instructions are not executed, but instead are bypassed by the processor. If the predicate register P1 contains a value of true (e.g., 1), the predicated instructions are executed.

Assuming for purposes of discussion that the predicate register P1 contains a value of true, execution of the first instruction 202 sets a variable Y equal to a method number (i.e., a unique identifier identifying the method entry block 200). Execution of the second instruction 204 calls an Event Detector routine 206.

The Event Detector routine 206 begins by executing an instruction 210 which increments a counter associated with the method entry block 200 to track how many times the method entry block 200 has called the Event Detector routine 206. Since, in this example, the event detected by the Event Detector routine 206 is execution of the Event Detector routine more than a predetermined number of times, instruction 212 is executed to increment a counter Z to track how many times the Event Detector routine 206 has been executed.

An if-then loop defined by instructions 214-222 is then initiated. In particular, if the value of the counter Z is greater than a threshold (i.e., a value corresponding to the predetermined number of executions of the Event Detector routine) (instruction 214), then instructions 216-218 are executed. Otherwise, control skips to instruction 222 where the if-then loop and the Event Detector routine 206 terminate, and control returns to the instruction immediately following instruction 204.

Assuming for purposes of discussion that the value in the counter Z has been incremented to a level greater than the threshold (instruction 214), the counter Z is re-set to zero (instruction 216), the predicate register P2 is set to true (instruction 218), and the predicate register P1 is set to false (instruction 220). The if-then loop and the Event Detector routine 206 then terminate (instruction 222), and control returns to the instruction immediately following instruction 204.

Although routine 206 is shown as a separate called routines in the example of FIG. 3, persons of ordinary skill in the art will readily appreciate that the routine 206 may alternatively be inlined (as predicated code) into block 200 instead of being called. Similarly, block 230 may alternatively be inlined (again, as predicated code) into block 232.

In the example of FIG. 3, after returning to the method entry block 200, control advances to another function or routine 230 in the same or another routine. Control advances from block 230 to another block 232. In the illustrated example, the block 232 is a target block which is to be profiled. Thus, it includes predicated instructions 234 and 236 which are predicated on predicate register P2. If the predicate register P2 contains a value of false (e.g., 0), the predicated instructions 234, 236 are not executed, but instead are bypassed by the processor. If the predicate register P2 contains a value of true (e.g., 1), the predicated instructions 234, 236 are executed.

Since in this example, the predicate register P2 has been set to store a value of true (see instruction 218), the predicated instructions 234, 236 are executed. In particular, the first predicated instruction 234 causes a variable X to be set to a value corresponding to a block number (i.e., a unique identifier identifying the target code 232). Execution of the second instruction 234 invokes a Profile Collector routine 240.

In the example of FIG. 3, the Profile Collector routine 240 begins by executing an instruction 242 which increments a counter associated with the target code 232 to track how many times the target code 232 has called the Profile Collector routine 240. Instruction 244 is then executed to increment a counter “#.of.samples” to track how many times the Profile Collector routine 240 has been executed.

To determine if a desired amount of profile data has been collected, an if-then loop defined by instructions 246-254 is initiated. In particular, if the value of the counter “#.of.samples” is greater than a threshold (instruction 246), then instructions 248-252 are executed. Otherwise, control skips to instruction 254 where the if-then loop terminates and control returns to the instruction immediately following instruction 236.

Assuming for purposes of discussion that the value in the counter “#.of.samples” has been incremented to a level greater than the threshold (instruction 246), the predicate register P2 is set to false (instruction 248), the counter Z is re-set to zero (instruction 250), and the predicate register P1 is set to true (instruction 250). The if-then loop then terminates (instruction 254), and control returns to the instruction immediately following instruction 236.

In the example of FIG. 3, after returning to the target block 232, control advances to another block 260. Alternatively, if the predicate register P2 contained the value “false” when control advanced from block 230 to the target block 232, control may have effectively advanced directly from block 230 to block 260 as shown by the control flow arrow 262 if all of the instructions in the target block are predicated on the predicate register P2.

The example of FIG. 4 is very similar to the example of FIG. 3. However, in the example of FIG. 4, the profile collection routine 240 is executed within a virtual machine 270 (after being just-in-time compiled by a just-in-time (JIT) compiler 272) if the value in the predicate register P2 is set to true. Otherwise, the profile collection routine is not executed. As in the example of FIG. 3, the predicate register P2 is re-set to a value of false (instruction 348) when a desired amount of profile collection has been completed (instruction 346).

Unlike the example of FIG. 3, in the example of FIG. 4, a modified event detector routine 306 is resident within a garbage collector 274. Whenever the garbage collector is called (e.g., to release memory resources), the counter Z is incremented (instruction 312). If the value stored in the counter Z exceeds a predetermined value (instruction 314), the counter Z is re-set to zero (instruction 316) and the predicate register P2 is set to true (instruction 318) to re-start profile data collection.

Persons of ordinary skill in the art will appreciate that, unlike the example of FIG. 3, the example of FIG. 4 does not use predicate register P1. Therefore, although all of the blocks of FIGS. 2A-2B are present in the example of FIG. 3, blocks 100, 108, 118, and 124 of FIGS. 2A-2B are not performed by the program of FIG. 4. Instead, in the example of FIG. 4, control returns from the “no” edge of block 116 to block 110 and from block 122 to block 104 in FIGS. 2A-2B.

Whereas the examples of FIGS. 3 and 4 globally reserved one or more predicate registers for profile instrumentation purposes, it is alternatively possible to use locally assigned predicate register(s) instead of, or in addition to, globally reserved predicate registers for profile instrumentation. For example, a predicate register that is local to a region being profiled for block/edge counts may be used for switching the profile instrumentation on and off. In such an example, since the predicate register is local to the region, it can be assigned and allocated by the compiler's register allocation phase just like any other local predicate register used in the block.

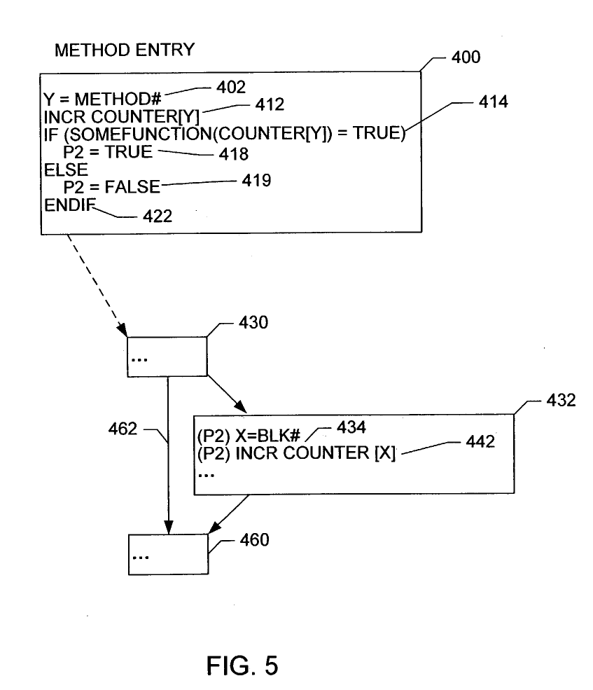

An example illustrating the usage of a local predicate register to start and stop profile collection is shown in FIG. 5. In this example, the compiler adds instrumentation code to count the number of times a routine of interest is invoked at the entry of the routine. The instrumented code at the entry of the routine also sets the local predicate register value used to invoke the execution of the more expensive (in terms of overhead) and detailed profile collection code.

More specifically, in the example of FIG. 5, a method entry block 400 is provided with instrumentation code to count the number of times the routine is invoked. For instance, the first instruction 402 sets a variable Y equal to a method number (i.e., a unique identifier identifying the method entry block 400). An Event Detector routine then begins by executing an instruction 412 to increment a counter associated with the method entry block 400 to track how many times method entry block 400 has been entered.

An if-then loop defined by instructions 414-422 is then initiated. In particular, if the value of the counter Y meets a preset sampling criteria such as exceeding a threshold (i.e., a value corresponding to a predetermined number of entries to the method entry routine 400) (instruction 414), then instruction 418 is executed to set the value in the predicate register P2 to true to start profile collection. Otherwise, control skips to instruction 419 where the value of the predicate register P2 is set to false to ensure profile data collection is not initiated. Control then advances from either instruction 418 or instruction 419 to instruction 422 where the if-then loop and the method entry routine 400 terminate.

In the example of FIG. 5, after completion of the method entry block 400, control advances to another block 430. Control may then advance from block 430 to block 432. In the illustrated example, the block 432 is a target block which is to be profiled. Thus, it includes predicated instructions 434 and 442 which are predicated on predicate register P2. If the predicate register P2 contains a value of false (e.g., 0), the predicated instructions 434, 442 are not executed, but instead are bypassed by the processor. If the predicate register P2 contains a value of true (e.g., 1), the predicated instructions 434, 442 are executed.

Assuming for purposes of discussion that the predicate register P2 has been set to store a value of true (see instruction 418), the first predicated instruction 434 causes a variable X to be set to a value corresponding to a block number (i.e., a unique identifier identifying the target block 432). Execution of the second instruction 442 increments a counter associated with the target block 432 to track how many times the target block 432 has been executed.

In the example of FIG. 5, control advances from the target block 432 to another block 460.

By varying the frequency of setting the local predicate register to true with respect to the method invocation count, different sampling rates may be achieved. For example, if a basic profile of the target block 432 is desired only once every sixteen invocations of the method entry routine 400, the local predicate register P2 may be set to true only when, for example, the last four bits of the corresponding method invocation counter Y are zero. Otherwise the predicate register P2 is set to false. Under such an approach, pseudo code instruction 414 of FIG. 5 may be replaced by an instruction such as: “if ((counter [Y]& 0×F)==0).”

From the foregoing, persons of ordinary skill in the art will appreciate that two or more predicate registers 14 may be used to create a hierarchical profiling mechanism as exemplified by FIG. 3. For example, a first predicate register 14 may be used to turn on and off a second predicate controlling a second type or detail level of profiling code. The value in the first predicate register 14 may control the setting of the second predicate register 14 such that the first profiling code is executed at a first frequency and the second profiling code is executed at a second, lower frequency. Thus, the first profiling code may obtain a relatively coarse level of profile data collection and the second profiling code may obtain a relatively fine level of profile data collection.

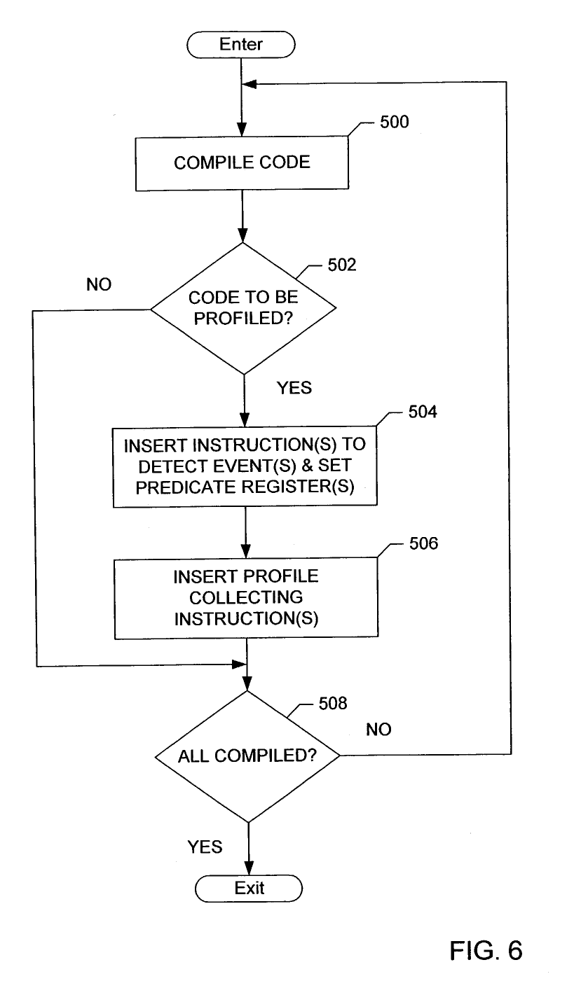

An example program which may be executed by a compiler to implement the apparatus 10 of FIG. 1 is shown in FIG. 6. In the example of FIG. 6, the program begins when the compiler starts compiling the target program in accordance with its ordinary compiling techniques (block 500). When compiling a section of the target code, the compiler examines the compiled code to determine if any section(s) of the compiled program are to be profiled (block 502). If none of the compiled sections are to be profiled (block 502), control advances to block 508. Otherwise, control advances to block 504.

Assuming a section of compiled code is to be profiled (block 502), the compiler inserts one or more instruction(s) into the compiled code to detect one or more predetermined event(s) and to set one or more predicate register(s) to a predetermined state in response to detection of such an event (block 504). The compiler also inserts one or more profile collecting instruction(s) into the section(s) of the compiled code to be profiled (block 506). The profile collecting instruction(s) are only executed if one or more associated predicate register(s) are set to a predefined value by the event detection instruction(s) as explained in detail above.

At block 508, the compiler determines if all of the target program has been compiled. If there is still more code to compile (block 508), control returns to block 500. Otherwise, the program of FIG. 6 terminates.

From the foregoing, persons of ordinary skill in the art will appreciate that the disclosed methods and apparatus collect profile data using instrumentation/profile code with only a fraction of the overhead of full instrumentation. The disclosed methods and apparatus also avoid doubling the code size as was done in prior art instrumentation sampling and, thus, avoid the negative effects on the instruction cache, the trace cache, the TLB, and branch prediction hardware performance associated with such prior art. Indeed, the disclosed methods and apparatus may achieve better results than the prior art bursty-profiling technique with only one version of the code to be profiled.

The disclosed techniques may be used for effective, low-overhead instrumentation-based profiling in IPF compilation/translation systems such as just-in-time compilers in Java/CLR virtual machines, dynamic binary translators, and static compilers that perform profile-guided optimizations. In such dynamic compilation systems, the disclosed methods and apparatus allows the runtime compiler to detect and exploit profile shifts during execution with low profiling overhead.

From the foregoing persons of ordinary skill in the art will further appreciate that multiple sets of predicate registers may be employed where each of the predicate registers is used to control a different type of profiling.

Persons of ordinary skill in the art will further appreciate that a fixed set of predicate register(s) can be used to control profiling. Alternatively, global memory location(s) may be used to store the predicate value(s) and a compiler can manage the profiling predicate(s) by assigning predicate register(s) and loading the corresponding value(s) from the global memory location(s). The latter approach is advantageous in that the choice of the predicate register(s) is not fixed across routines, but is instead chosen locally within each routine. The memory location can be thread local (i.e., each execution thread has its own copy), method local (i.e., each routine has a private location), or global.

Persons of ordinary skill in the art will further appreciate that the profiling code may be presented directly at the location being profiled (in such circumstances, all of the profiling instructions are predicated). Alternatively, the profiling code may be located in a profiling method wherein the call to the method is predicated, but the instructions in the profiling method are not predicated. Alternatively, the profiling code may be located in a profiling method wherein the profiling code in the profiling method is predicated.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of collecting profile information with respect to target code comprising:
predicating execution of profile collection code on a predicate register value;
setting the predicate register value to a first predetermined value to permit execution of the profile information collection code to collect profile information with respect to the target code; and
setting the predicate register value to a second predetermined value to prevent execution of the profile collection code.

2. A method as defined in claim 1 wherein the predicate register value is set to the first predetermined value in response to occurrence of a predetermined event.

3. A method as defined in claim 2 wherein the predetermined event comprises at least one of: (a) invoking the target code a first predetermined number of times, (b) invoking a block executed by an operating system a second predetermined number of times, (c) invoking a virtual machine a third predetermined number of times, (d) invoking a lower level software layer a fourth predetermined number of times, (e) invoking a garbage collector a fifth predetermined number of times, (f) invoking a predetermined block a sixth predetermined number of times, (g) invoking a block associated with the target code a seventh predetermined number of times; (h) invoking a component of a virtual machine an eighth predetermined number of times, (i) elapse of a predetermined length of time, (j)observing a predetermined number of system events, and (k) observing a predetermined number of performance events with performance monitoring hardware.

4. A method as defined in claim 1 wherein the profile collection code collects data relating to at least one of: (a) a method/routine execution count, (b) a block execution count, (c) an edge execution count, (d) a path execution count, (e) a call graph edge execution count, (f) an argument value, (g) an argument type, and/or (h) a stride.

5. A method as defined in claim 1 wherein the profile collection code sets the predicate register value to the second predetermined value after a predetermined amount of profile information has been collected.

6. A method as defined in claim 1 wherein a predicate register to store the predicate register value is reserved for globally controlling execution of the profile information collection code.

7. A method as defined in claim 1 wherein a predicate register to store the predicate register value is local to the target code.

8. A method as defined in claim 1 wherein the predicate register value is stored in a memory location and a compiler assigns a predicate register and generates a load instruction to load the predicate register value stored in the memory location into the assigned predicate register.

9. A method as defined in claim 8 wherein the memory location is at least one of: a global memory location, a thread local memory location and a method local location.

10. A method as defined in claim 1 wherein the profile collection code is not executed by a processor if the predicate register value is the second predetermined value.

11. A method as defined in claim 1 wherein varying a frequency with which the predicate register value is set to the first predetermined value varies a sampling rate at which the profile information is collected.

12. A method of collecting profile information with respect to target code comprising:
setting a predicate value to a first predetermined value;
determining a number of entries into a predetermined block;
if the number of entries into the predetermined block meets a predetermined criteria, setting the predicate value to a second predetermined value; and
collecting the profile information with respect to the target code if the predicate value is the second predetermined value.

13. A method as defined in claim 12 wherein the predetermined block is at least one of: the target code, a block associated with the target code, a block executed by an operating system, and a component of a virtual machine.

14. A method as defined in claim 12 further comprising re-setting the predicate value to the first predetermined value to stop collecting the profile information.

15. A method as defined in claim 14 wherein re-setting the predicate value to the first predetermined value comprises re-setting the predicate value to the first predetermined value in response to occurrence of a predetermined event.

16. A method as defined in claim 12 wherein the profile information comprises at least one of (a) a method/routine execution count, (b) a block execution count, (c) an edge execution count, (d) a path execution count, (e) a call graph edge execution count, (f) an argument value, (g) an argument type, and/or (h) a stride.

17. A method as defined in claim 12 wherein the predicate value is stored in a predicate register which is globally reserved.

18. A method as defined in claim 12 wherein the predicate register is local to the target code.

19. A method as defined in claim 12 wherein the predicate register value is stored in a memory location and a compiler assigns and loads a predicate register with the predicate register value.

20. A method as defined in claim 19 wherein the memory location is at least one of: a global memory location, a thread local memory location and a method local location.

21. A method as defined in claim 12 wherein an instruction associated with the predicate value is not executed by a processor if the predicate value is the second predetermined value.

22. A method as defined in claim 12 wherein varying a frequency with which the predicate value is set to the second predetermined value varies a sampling rate at which the profile information is collected.

23. A method of compiling software comprising:
identifying a section of software to be profiled;
adding at least one instruction to the software to set a predicate register to a first predetermined value in response to occurrence of a predetermined event; and
inserting at least one profile collecting instruction into the software, wherein the at least one profile collecting instruction is only executed if the predicate register contains the first predetermined value.

24. A method as defined in claim 23 wherein the predetermined event comprises at least one of: (a) invoking the section of software to be profiled a first predetermined number of times, (b) invoking a block executed by an operating system a second predetermined number of times, (c) invoking a virtual machine a third predetermined number of times, (d) invoking a lower level software layer a fourth predetermined number of times, (e) invoking a garbage collector a fifth predetermined number of times, (f) invoking a predetermined block a sixth predetermined number of times, (g) invoking a block associated with the section of software to be profiled a seventh predetermined number of times; (h) invoking a component of a virtual machine an eighth predetermined number of times, (i) elapse of a predetermined length of time, (j)observing a predetermined number of system events, and (k) observing a predetermined number of performance events with performance monitoring hardware.

25. A method as defined in claim 23 wherein the at least one profile collecting instruction collects data relating to at least one of: (a) a method/routine execution count, (b) a block execution count, (c) an edge execution count, (d) a path execution count, (e) a call graph edge execution count, (f) an argument value, (g) an argument type, and/or (h) a stride.

26. A method as defined in claim 23 wherein the at least one profile collecting instruction includes an instruction to set the predicate register to a second predetermined value after at least one of a predetermined amount of profile information has been collected and a predetermined event has occurred.

27. A method as defined in claim 26 wherein the at least one profile collecting instruction is not executed by a processor if the predicate register is set to the second predetermined value.

28. A method as defined in claim 26 wherein the at least one instruction is not executed by a processor if the predicate register is set to the first predetermined value.

29. A method as defined in claim 23 wherein the at least one profile collecting instruction includes an instruction to set the predicate register to a second predetermined value after a predetermined amount of time has elapsed.

30. A method as defined in claim 23 wherein the predicate register is globally reserved.

31. A method as defined in claim 23 wherein the predicate register is local to the section of software to be profiled.

32. A method as defined in claim 23 wherein varying a frequency with which the predicate register is set to the first predetermined value varies a sampling rate at which the at least one profile collecting instruction is executed.

33. A method of compiling software comprising:
inserting at least one profile collecting instruction into the software, wherein the at least one profile collecting instruction is only executed if a predicate register contains a first predetermined value;
compiling the software;
receiving profile information gathered by executing the at least one profile collecting instruction; and
re-compiling the software based on the received profile information.

34. A method as defined in claim 33 wherein the at least one profile collecting instruction collects data relating to at least one of: (a) a method/routine execution count, (b) a block execution count, (c) an edge execution count, (d) a path execution count, (e) a call graph edge execution count, (f) an argument value, (g) an argument type, and/or (h) a stride.

35. A method as defined in claim 33 wherein the at least one profile collecting instruction includes an instruction to set the predicate register to a second predetermined value after a predetermined amount of profile information has been collected.

36. An apparatus to collect profile information with respect to target code comprising:
an event detector to detect occurrence of a predetermined event;
a predicate setter to set a predicate register to a first predetermined value in response to detection of the predetermined event; and
a profile data collector to collect profile information with respect to the target code when the predicate register contains the first predetermined value.

37. An apparatus as defined in claim 36 wherein the predetermined event comprises at least one of: (a) invoking the target code a first predetermined number of times, (b) invoking a block executed by an operating system a second predetermined number of times, (c) invoking a virtual machine a third predetermined number of times, (d) invoking a lower level software layer a fourth predetermined number of times, (e) invoking a garbage collector a fifth predetermined number of times, (f) invoking a predetermined block a sixth predetermined number of times, (g) invoking a block associated with the target code a seventh predetermined number of times; (h) invoking a component of a virtual machine an eighth predetermined number of times, (i) elapse of a predetermined length of time, (j)observing a predetermined number of system events, and (k) observing a predetermined number of performance events with performance monitoring hardware.

38. An apparatus as defined in claim 36 wherein the profile data collector collects data relating to at least one of: (a) a method/routine execution count, (b) a block execution count, (c) an edge execution count, (d) a path execution count, (e) a call graph edge execution count, (f) an argument value, (g) an argument type, and/or (h) a stride.

39. An apparatus as defined in claim 36 wherein the predicate setter sets the predicate register to a first predetermined value after a predetermined amount of profile information has been collected by the profile data collector.

40. An apparatus as defined in claim 36 wherein the predicate setter sets the predicate register to a first predetermined value after a predetermined amount of time has elapsed.

41. An apparatus as defined in claim 36 wherein the predicate register is globally reserved.

42. An apparatus as defined in claim 36 wherein the predicate register is a locally allocated register.

43. An apparatus as defined in claim 36 wherein varying a frequency with which the predicate register value is set to the first predetermined value varies a sampling rate at which the profile information is collected.

44. An article of manufacture storing machine readable instructions which, when executed, cause a machine to:
predicate execution of profile collection code on a predicate register value;
set the predicate register value to a first predetermined value to permit execution of the profile information collection code to collect profile information with respect to target code; and
set the predicate register value to a second predetermined value to prevent execution of the profile collection code.

45. An article of manufacture as defined in claim 44 wherein the machine readable instructions cause the machine to set the predicate register value to the first predetermined value in response to occurrence of a predetermined event.

46. An article of manufacture as defined in claim 45 wherein the predetermined event comprises at least one of: (a) invoking the target code a first predetermined number of times, (b) invoking a block executed by an operating system a second predetermined number of times, (c) invoking a virtual machine a third predetermined number of times, (d) invoking a lower level software layer a fourth predetermined number of times, (e) invoking a garbage collector a fifth predetermined number of times, (f) invoking a predetermined block a sixth predetermined number of times, (g) invoking a block associated with the target code a seventh predetermined number of times; (h) invoking a component of a virtual machine an eighth predetermined number of times, (i) elapse of a predetermined length of time, (j)observing a predetermined number of system events, and (k) observing a predetermined number of performance events with performance monitoring hardware.

47. An article of manufacture as defined in claim 44 wherein the profile collection code collects data relating to at least one of: (a) a method/routine execution count, (b) a block execution count, (c) an edge execution count, (d) a path execution count, (e) a call graph edge execution count, (f) an argument value, (g) an argument type, and/or (h) a stride.

48. An article of manufacture as defined in claim 44 wherein machine readable instructions cause the machine to set the predicate register value to the second predetermined value after a predetermined amount of profile information has been collected.

49. An article of manufacture as defined in claim 44 wherein machine readable instructions cause the machine to set the predicate register value to the second predetermined value after a predetermined amount of time has elapsed.

50. An article of manufacture as defined in claim 44 wherein the profile collection code is not executed by the machine if the predicate register value is the second predetermined value.

51. An article of manufacture as defined in claim 44 wherein varying a frequency with which the predicate register value is set to the first predetermined value varies a sampling rate at which the profile information is collected.

52. An article of manufacture storing machine readable instructions which, when executed, cause a machine to:
identify a section of software to be profiled;
add at least one instruction to the software to set a predicate register to a first predetermined value in response to occurrence of a predetermined event; and
insert at least one profile collecting instruction into the software, wherein the at least one profile collecting instruction is only executed if the predicate register contains the first predetermined value.

53. An article of manufacture as defined in claim 52 wherein the predetermined event comprises at least one of: (a) invoking the section of software to be profiled a first predetermined number of times, (b) invoking a block executed by an operating system a second predetermined number of times, (c) invoking a virtual machine a third predetermined number of times, (d) invoking a lower level software layer a fourth predetermined number of times, (e) invoking a garbage collector a fifth predetermined number of times, (f) invoking a predetermined block a sixth predetermined number of times, (g) invoking a block associated with the section of software to be profiled a seventh predetermined number of times; (h) invoking a component of a virtual machine an eighth predetermined number of times, (i) elapse of a predetermined length of time, (j)observing a predetermined number of system events, and (k) observing a predetermined number of performance events with performance monitoring hardware.

54. An article of manufacture as defined in claim 52 wherein the at least one profile collecting instruction collects data relating to at least one of: (a) a method/routine execution count, (b) a block execution count, (c) an edge execution count, (d) a path execution count, (e) a call graph edge execution count, (f) an argument value, (g) an argument type, and/or (h) a stride.

55. An article of manufacture as defined in claim 52 wherein the at least one profile collecting instruction includes an instruction to set the predicate register to a second predetermined value after a predetermined amount of profile information has been collected.

56. An article of manufacture as defined in claim 55 wherein the at least one profile collecting instruction is not executed by the machine if the predicate register is set to the second predetermined value.

57. An article of manufacture as defined in claim 55 wherein the at least one instruction is not executed by the machine if the predicate register is set to the first predetermined value.

58. An article of manufacture as defined in claim 52 wherein the at least one profile collecting instruction includes an instruction to set the predicate register to a second predetermined value after a predetermined amount of time has elapsed.

59. An article of manufacture as defined in claim 52 wherein the predicate register is globally reserved.

60. An article of manufacture as defined in claim 52 wherein the predicate register is local to the section of software to be profiled.

61. An article of manufacture as defined in claim 52 wherein varying a frequency with which the predicate register is set to the first predetermined value varies a sampling rate at which the at least one profile collecting instruction is executed.

62. A method of collecting profile information with respect to target code comprising:
predicating execution of a first profile collection code on a first predicate register value;
setting the first predicate register value to a first predetermined value to permit execution of the first profile information collection code to collect profile information with respect to the target code; and
setting the first predicate register value to a second predetermined value to prevent execution of the first profile collection code;
predicating execution of a second profile collection code on a second predicate register value;
setting the second predicate register value to a first predetermined value to permit execution of the second profile information collection code to collect profile information with respect to the target code; and
setting the second predicate register value to a second predetermined value to prevent execution of the second profile collection code.

63. A method as defined in claim 62 wherein the first profile information collection code collects a first type of profile information and the second profile information collection code collects a second type of profile information.

64. A method as defined in claim 63 setting the second predicate register to the first predetermined value is dependent on code that is predicated on the first predicate register.

65. A method as defined in claim 64 wherein the second predicate register is set to the first predetermined value less frequently than the first predicate register is set to the first predetermined value.

66. A method as defined in claim 62 wherein the second predicate register is set to the first predetermined value less frequently than the first predicate register is set to the first predetermined value.
